(19) United States
(12) Patent Application Publication
(10) Pub. No.: US 2009/0050343 A1
(43) Pub. Date: Feb. 26, 2009

(54) Process and apparatus for drilling holes in soft materials.

(76) Inventors: Ronald D. Smith, Anderson, IN (US); Mark A. Noffsinger, Mattawan, MI (US)

Correspondence Address: RITCHISON LAW OFFICES, PC;John D. Ritchison, Suite A, 115 East Ninth Street, Anderson, IN, 46016-1509, US

(21) Appl. No.: 12/151,856

(22) Filed: May 9, 2008

Related U.S. Application Data
(60) Provisional application No. 60/957,194, filed on Aug. 22, 2007.

(51) Int. Cl. B23Q 5/02

(52) U.S. Cl. 173/216

(57) ABSTRACT

This device is a simple mechanical device that converts the rotary motion of a drill motor to an oscillating or reciprocating motion. The device is for use in unique, non-surgical operations with soft, fibrous materials such as carpets and other fiber based materials. The device drills a close tolerance hole with drive shafts in line or offset to the driven shaft. A general reciprocating drive system is comprised of a reciprocating drive device—offset drive and eccentric bars; a turning drive means such as a drill or the like; a drive structure member such as a gear, plate or the like; a reciprocation configuration of various members such as the eccentric linkage to the reciprocating driven structure member such as a gear, plate, linkage or the like; a device encasement; a connection means of members to an encasement; and a driven output means.

### CROSS-REFERENCE TO RELATED APPLICATIONS

None

### FIELD OF INVENTION

This invention relates to a simple mechanical device that converts the rotary motion of a drill motor to an oscillating or reciprocating motion. This is proposed for non-surgical uses. Several prototypes have been built to successfully test different shaft geometry, drill bits, and degrees of rotation of the bit. They have been tested and found to solve the problems described. One model rotates about 120 to 130 degrees and uses a three fluted drill. The device drills a close tolerance hole and the three flutes are necessary to accommodate the limited rotation angle. The three fluted bits are sometimes difficult to find and more costly. Another model rotates about two hundred (200) degrees and uses a standard twist drill bit. Empirically it also works quite well. The other variation of the prototypes is in the geometry of the input shaft and the output shaft. Versions or embodiments have the shafts in line, offset and electronically accomplished. These were done for application convenience.

### FEDERALLY SPONSORED RESEARCH

None.

### SEQUENCE LISTING OR PROGRAM

None.

### BACKGROUND

### Field of Invention

Various drills over the ages have tried to address the need to drill safely through soft materials. The surgical field has addressed soft tissues but did not anticipate other uses for a reciprocating or oscillating drill device.

A. Introduction of the Problems Addressed

Drilling through soft materials such as carpets, foam rubber, upholstery fabrics, insulations etc. is very difficult if not dangerous because drill bits tend to catch on these materials and get wrapped around the bit which can cause unintended damage to the material and/or twist the drill motor out of the operator's hands. Orthopedic surgeons have had the same kind of problems when drilling in bones. If tissue comes in contact with the drill bit, it can get wrapped around the bit and cause considerable tissue and/or muscle damage.

Several prototypes have been built to successfully test different shaft geometry, drill bits, and degrees of rotation of the bit. They have been tested and found to solve the problems described. One model rotates about 120 to 130 degrees and uses a three fluted drill. The device drills a close tolerance hole and the three flutes are necessary to accommodate the limited rotation angle. The three fluted bits are sometimes difficult to find and more costly. Another model rotates about two hundred (200) degrees and uses a standard twist drill bit. Empirically it also works quite well. The other variation of the prototypes is in the geometry of the input shaft and the output shaft. Versions or embodiments have the shafts in line, offset and electronically accomplished. These were done for application convenience.

B. Prior Art

An example of a process and apparatus for drilling holes in soft materials, in non-surgical procedures was shown by U.S. Pat. No. 4,111,208 (FIG. 8A) issued to Leuenberger on Sep. 5, 1978. This taught a process and apparatus for drilling holes in hard materials in surgical procedures, comprising driving a drilling tool with a movement of alternating rotation with an amplitude of less than one revolution. The tool can be driven from a motor having unidirectional continuous rotatable movement through a convertor which transforms this movement into the alternating rotation. The drilling tool can covered by a member which feeds the waste cutting materials rearwardly into an enclosed chamber. The apparatus can also be provided with a member that covers the drill during an insertion thereof through cut tissue prior to the drilling operation. This drill did not claim non-surgical uses or common, simple devices with less parts and precision of the claimed invention.

A U.S. Pat. No. 4,955,888 (FIG. 8B) issued to Slocum (1990) teaches a biradial saw including a biradial saw blade having an elongate, arcuate body with a cutting end that is constructed to penetrate a solid substance. The blade's body is formed with inner and outer arcuate surfaces whose curvature radii are substantially equal but oriented relative to offset axes of curvature. Also included is a means for producing oscillating motion, and a means for attaching the blade's rear end to the oscillating-motion-producing means.

A radiolucent orthopedic chuck was shown and taught by the U.S. Pat. No. 5,030,222 (FIG. 8C) issued to Calandruccio, et al. (1991). The patent taught a radiolucent orthopedic chuck includes a housing having a driver stem protruding from the top surface and a drill bit protruding from the underside in radially spaced relation from the driver stem so as to displace a drill secured to the driver stem from the axis of the drill bit so that fluoroscopy may be used to ensure accurate alignment of the drill bit with a hole of an intramedullary nail both prior to and during its operation. A drive train interconnects the driver stem and drill bit for rotation in unison. All parts of the chuck but for the drill bit preferably radiolucent.

A Method of fixating bone by driving a wire through oscillation was taught by the U.S. Pat. No. 6,110,174 (FIG. 8D) issued to Nichter (2000). The patent taught a method and/or apparatus is provided for bone fixation which includes oscillating a wire about a longitudinal axis, advancing the oscillating wire into the bone tissue, and leaving the wire in the bone tissue as a fixation element. The apparatus in the present invention may be a self-contained unit for providing oscillatory motion to a chuck configured for releasably engaging a K-wire or the like, or may include a drive gear for use with a conventional rotor and drill for accomplishing the same oscillatory action.

As far as known, there are no known devices at the present time on the market that can effectively drill through these materials and also effectively drill through wood, bones, aluminum, copper, steel, etc. It is believed that this device is made with fewer parts, of a more durable design, and with comparatively less expense as compared to other drill and turning devices for soft materials in use today.

### SUMMARY OF THE INVENTION

This invention relates to a simple mechanical device that converts the rotary motion of a drill motor to an oscillating or reciprocating motion. This is proposed for non-surgical uses.

The preferred embodiment of the device is comprised essentially of A general reciprocating drive system 31 comprised of a reciprocating drive device—offset drive and eccentric bars 32; a turning drive means 34 such as a drill or the like; a drive structure member 35 such as a gear, plate or the like; a reciprocation configuration 36 of various members such as the eccentric linkage 37 to the reciprocating driven structure member 38 such as a gear, plate, linkage or the like; a device encasement 40; a connection means 39 of members to an encasement 40; and a driven output means. Other alternative embodiments include embodiments such as a reciprocating drive device 33 with inline drive and eccentric bars; a reciprocating drive device 33A with inline drive, gears and eccentric bars; and an electronic controlled reciprocating turning device 55 such as a drill or the like.

The newly invented drilling device and system features various configurations to accomplish the desired output within the scope and spirit of the unique device and new use described herein.

### OBJECTS AND ADVANTAGES

There are several objects and advantages of the drilling device and system. There are currently no known turning or drill devices that are effective at providing the objects of this invention. The following TABLE A summarizes various advantages and objects of the drilling device and system. This list is exemplary and not limiting to the many advantages offered by this new device.

TABLE A
Various Advantages and Objects

| Item | Description of Advantage |
|---|---|
| 1 | Smooth operation of turning |
| 2 | No chatter |
| 3 | Durable |
| 4 | Multi-use |
| 5 | Simple |
| 6 | Straight or Offset Design |
| 7 | Mechanically simple |
| 8 | Minimizes wobble without Ball Bearings |
| 9 | Bearings/Drill bit retainer block would be |
| | inexpensive and easy to replace by user |
| 10 | Uses the same power supply as the existing drill and |
| | would be interchangeable with it |
| 11 | Do not have to attach a drill motor |
| 12 | Less awkward |
| 13 | Easily adjusts to differing torque and speed |
| | requirements |
| 14 | Could have handles for left and right hand operations |
| | and convenience |
| 15 | Different sized drill bits would require different |
| | bearing/retainer blocks unless the drill bits were |
| | made with the same sized upper shank |
| 16 | Bevel gear or other gears is molded onto the drill bit |
| | or modified to have a permanent gear |
| 17 | Future design changes or operating charges would be |
| | easily incorporated |

Finally, other advantages and additional features of the new drilling device and system will be more apparent from the accompanying drawings and from the full description of the device. For one skilled in the art of devices and improvements for turning and drilling devices, it is readily understood that the features shown in the examples with this mechanism are readily adapted for improvement to other types of turning and drilling devices and systems.

### DESCRIPTION OF THE DRAWINGS—FIGURES

The accompanying drawings, which are incorporated in and constitute a part of this specification, illustrate a preferred and alternative embodiments for the drilling device and system. The drawings together with the summary description given above and a detailed description given below serve to explain the principles of the drilling device and system. It is understood, however, that the device is not limited to only the precise arrangements and instrumentalities shown.

FIG. 1 Elements of general reciprocating drive system.

FIGS. 2 A and 2 B are sketches of the reciprocating drive device—offset drive and eccentric bars.

FIGS. 3 A and 3 B are additional sketches of the reciprocating drive device—offset drive and eccentric bars.

FIGS. 4 A and 4 B are sketches of the reciprocating drive device—inline drive and eccentric bars.

FIGS. 5 A and 5 B are sketches of the reciprocating drive device—inline drive, gears and eccentric bars.

FIGS. 6 A and 6 B are sketches of the electronic controlled reciprocating turning device such as a drill or the like.

FIGS. 7 A and 7 B are sketches that show The problem addressed.

FIGS. 8 A through 8 D are prior art of other turning devices.

### DESCRIPTION OF THE DRAWINGS—REFERENCE NUMERALS

The following list refers to the drawings:

| Ref # | Description |
|---|---|
| 31 | General reciprocating drive system |
| 32 | Reciprocating drive device - offset drive and eccentric bars |
| 33 | Reciprocating drive device - inline drive and eccentric bars |
| 33A | Reciprocating drive device - inline drive, gears and eccentric bars |
| 34 | Rotational Turning drive means such as a drill |
| 34A | Means to connect drive to transfer member |
| 35 | Drive transfer member such as a gear, plate or the like |
| 35A | Intermediate driven structure member such as a gear, plate, linkage |
| | or the like |
| 36 | Reciprocation configuration of members |
| 37 | Eccentric linkage |
| 37A | Secondary linkage |
| 38 | Reciprocating driven structure member such as a gear, plate, |
| | linkage or the like |
| 39 | Connection means of members to an encasement |
| 40 | Device encasement or outer shell |
| 41 | Driven output means such as a reciprocating shaft |
| 41 | Means to connect output means to tool or tool chuck |
| 42 | Intermediate structure mounting means |
| 45 | Device support handle |
| 46 | Example of reciprocating drill |
| 47 | Simple fluted drill bit |
| 48 | Simple bi-radial saw |
| 49 | Example of a rotating gear drive |
| 50 | Reciprocal gear and eccentric linkage |
| 51 | Turning means such as a drill with reciprocating output |
| 52 | Electronically controlled reciprocating component |
| 53 | Electronics control |
| 54 | Tool chuck means |
| 55 | Electronic controlled reciprocating turning device such as a drill |
| | or the like |
| 56 | Operating switch |
| 57 | Single fiber wrapping around rotating tool |
| 58 | Multiple fibers not wrapping around reciprocating tool |
| P | Operator or person |

### DETAILED DESCRIPTION OF PREFERRED EMBODIMENT

The present mechanism is a special drilling device and system that has been developed for use by a person to provide a method to drill through soft and fibrous materials in non-surgical uses. The preferred embodiment of the device is a general reciprocating drive system 31 comprised of Reciprocating drive device—offset drive and eccentric bars 32; a turning drive means 34 such as a drill or the like; a drive structure member 35 such as a gear, plate or the like; a reciprocation configuration 36 of various members such as the eccentric linkage 37 to the reciprocating driven structure member 38 such as a gear, plate, linkage or the like; a device encasement 40; a connection means 39 of members to an encasement 40; and a driven output means. One skilled in the art of turning and drill devices for soft materials will appreciate the varied uses anticipated by this new drilling device and system. The newly invented drilling device and system features very few parts. In operation, the new device may be easily and quickly used for turning and drilling in non-surgical uses.

The structural members of the drilling device and system are potentially made of various materials. The device may have alternative embodiments described below.

The improvement over the existing art is providing a device that is:

A smooth operation of turning; has limited or no chatter; is durable; has multi-uses; is simple; may be configured with a straight or offset Design; is essentially mechanically simple; minimizes wobble without ball bearings; has bearings or drill bit retainer block that may be inexpensive and easy to replace by user; uses the same power supply as the existing drill and would be interchangeable with it; does not have to attach a drill motor; is less awkward; easily adjusts to differing torque and speed requirements; can have handles for left and right hand operations and convenience; may accommodate different sized drill bits would require different bearing/retainer blocks unless the drill bits were made with the same sized upper shank; may have a bevel gear or other gears is molded onto the drill bit or modified to have a permanent gear; and adapts easily to future design changes or operating charges for easy incorporation.

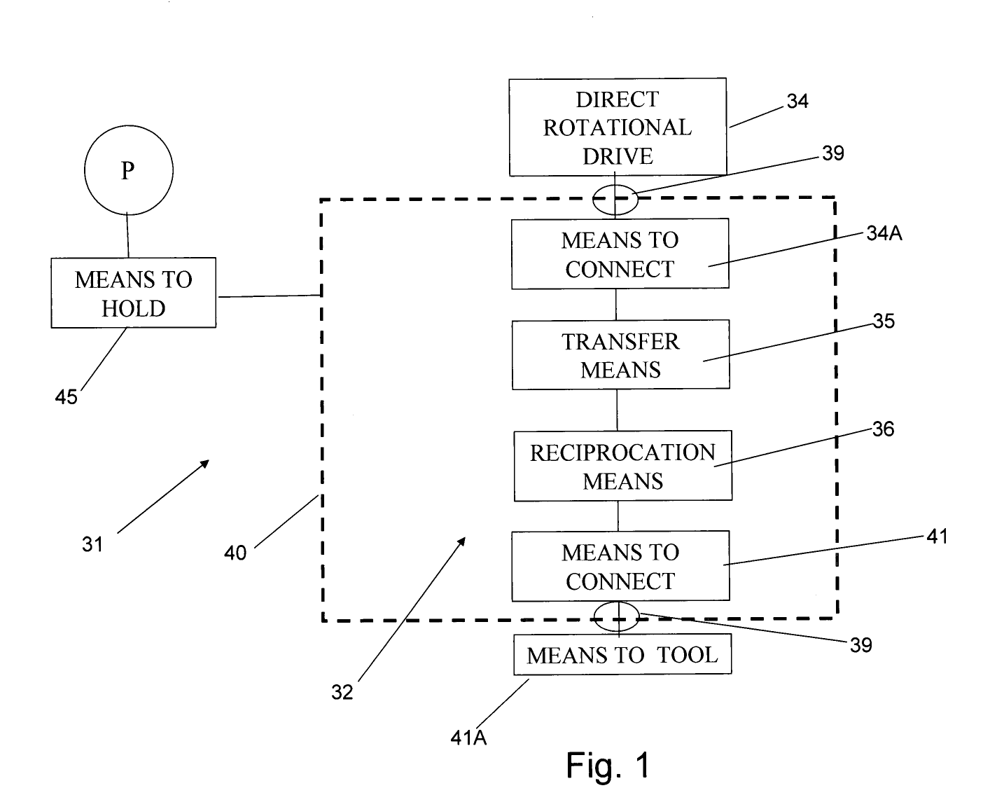

There are shown in FIGS. 1-8 a complete operative embodiment of the drilling device and system and prior related art. In the drawings and illustrations, one notes well that the FIGS. 1-8 demonstrate the general configuration and use of this invention. The preferred embodiment of the device is comprised of only a few parts as shown in the sketches and drawings. The preferred embodiment of the device is comprised essentially of a reciprocating drive device—offset drive and eccentric bars 32; a turning drive means 34 such as a drill or the like; a drive structure member 35 such as a gear, plate or the like; a reciprocation configuration 36 of various members such as the eccentric linkage 37 to the reciprocating driven structure member 38 such as a gear, plate, linkage or the like; a device encasement 40; a connection means 39 of members to an encasement 40; and a driven output means. Other alternative embodiments also exist and are shown in the accompanying drawings. One skilled in the art of drilling devices and systems will appreciate the plethora and varied uses anticipated by this new special drilling device and system. The newly invented drilling device and system features very few parts. In operation, the new device may be easily and quickly used to drill into soft materials in non-surgical uses.

Various important features of these components are delineated in FIGS. 1-8 of the sketches and drawings and are described below. The description is in appropriate detail for one skilled in the art to appreciate their importance and functionality to the drilling device and system 31, 32, 33.

The accompanying drawings, which are incorporated in and constitute a part of this specification, illustrate an embodiment of the drilling device and system 31,32 that is preferred. The drawings together with the summary description given above and a detailed description given below serve to explain the principles of the drilling device and system 31,32. It is understood, however, that the drilling device and system is not limited to only the precise arrangements and instrumentalities shown. This is exemplified with the described alternative embodiments.

FIG. 1 shows the elements of general reciprocating drive system. A general reciprocating drive system 31 made of durable material. A reciprocating drive means 32 comprising a direct rotational drive means 34; a means to connect to a direct rotational drive means 34A; a transfer member 35; a reciprocation means 36; an output means 41; and means to connect to a tool 41A. The device has an encasement 40; a means to connect 39 the components of the drive means 31 to the encasement means 40; and a means 45 to hold the encasement whereby the rotational drive motion is smoothly transferred into a reciprocating motion to use for turning and drilling soft materials by a person P operating the system. One notes this interconnection system results in a reciprocation configuration 36 of the various members. The reciprocally or oscillating driven structure member 38 is connected to an output means 41 such as a shaft or the like with a means to ultimately connect to a tool or tool chuck 54.

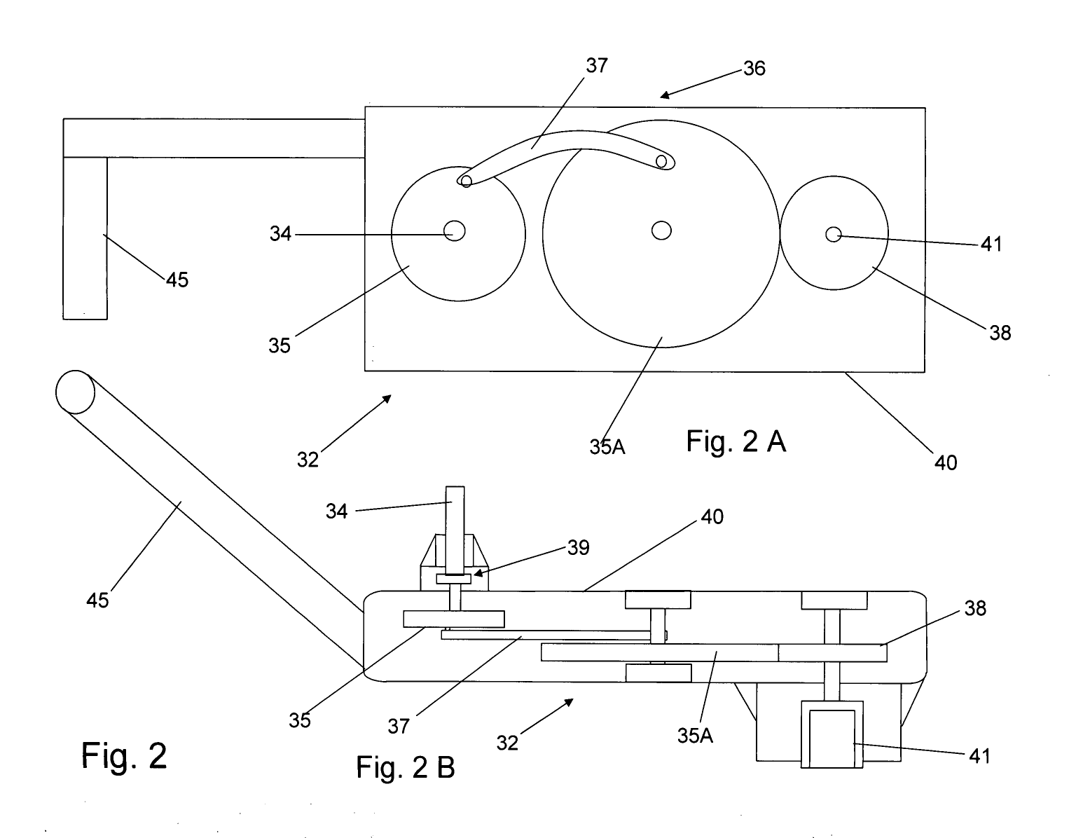

FIGS. 2 A and 2 B are sketches of a reciprocating drive device 32 with offset drive and eccentric bars. The device is in an encasement 40 with a handle 45. The device 32 is comprised of a drive means 34 secured to a drive structure 35 such as a gear or plate. This structure 35 is eccentrically linked by linkage 37 to an intermediate gear 35A. The driven structure 35A in turn directly drives the output gear 38 which is secured in turn to the output means 41, here a shaft or the like. Note in FIG. 2 B one sees that the input means 34 and output means 41 are offset.

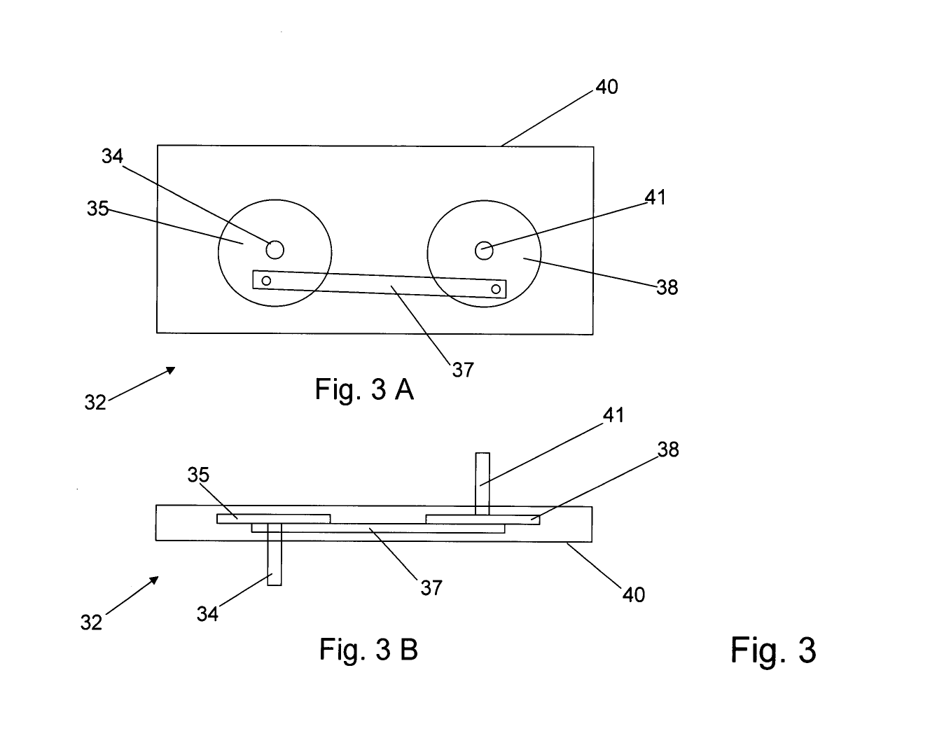

FIGS. 3 A and 3 B are additional sketches of another reciprocating drive device offset drive and eccentric bars. In this view there is no intermediate structure 35A and the drive plate 35 is eccentrically linked by structure 37 to the driven plate 38. Other components are similar to FIGS. 2 A and B.

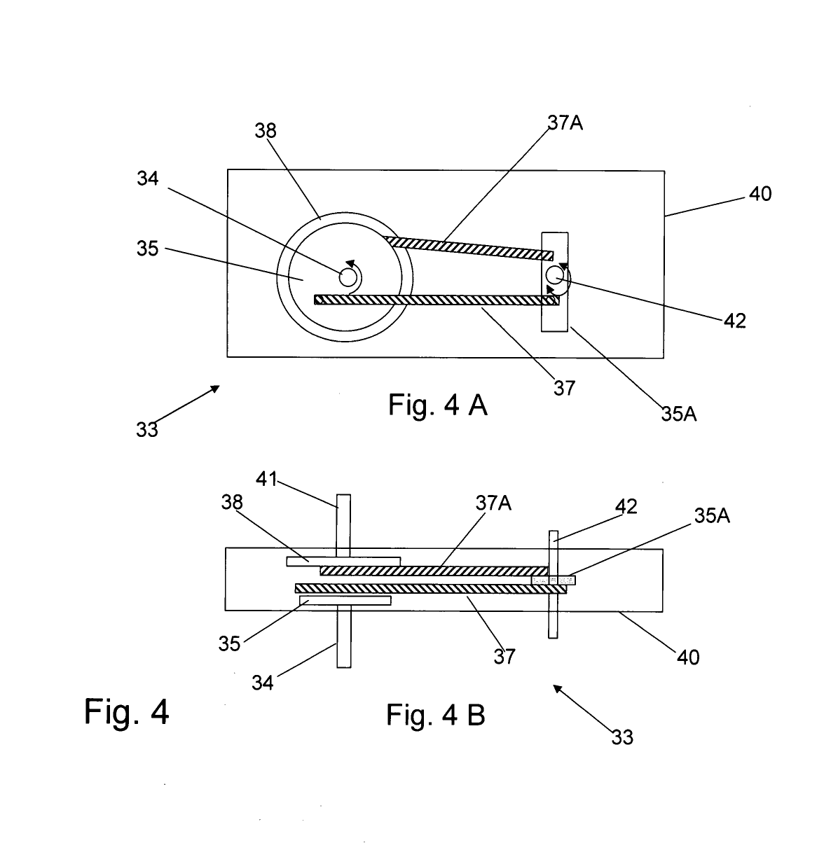

FIGS. 4 A and 4 B are sketches of an alternative embodiment 33 of the reciprocating drive device with an inline drive 34 and driven means 41. The device 33 uses an eccentric bar 37 rotatably connected to a drive plate 35 and an intermediate linkage bar 35A. This intermediate linkage bar 35A is rotatably supported in the encasement 40 by a support means 42. The intermediate linkage 35A is then rotatably linked by a secondary linkage 37A. This secondary linkage 37A is in turn rotatably connected to the reciprocating driven member 38 or structure which in turn is secured to the driven output means 41 such as a shaft. One notes the input rotation to shaft 34 is converted to a reciprocating motion at the intermediate bar 35A and output member 38 and shaft 41.

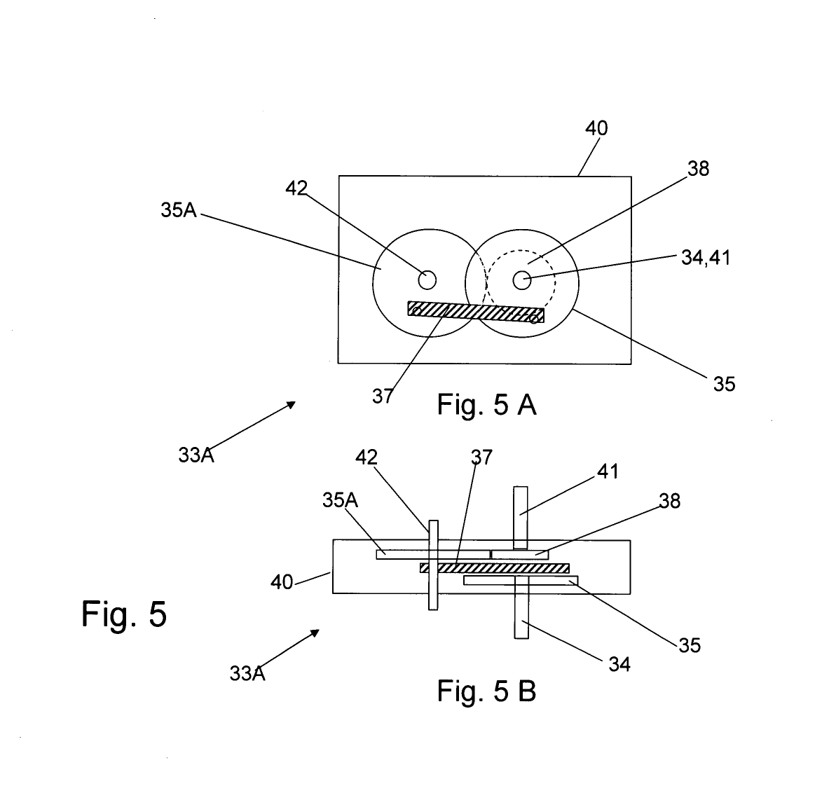

FIGS. 5 A and 5 B are sketches of an alternative embodiment 33A of the reciprocating drive device with an inline rotating drive 34 and reciprocating driven means 41. The device 33A uses an eccentric bar 37 rotatably connected to a rotating drive plate 35 and a reciprocating intermediate linkage gear 35A. This intermediate gear 35A is rotatably supported in the encasement 40 by a support means 42. The intermediate linkage gear 35A is then directly engaged with a driven gear 38. The reciprocating driven member 38 is in turn secured to the driven output means 41 such as a shaft.

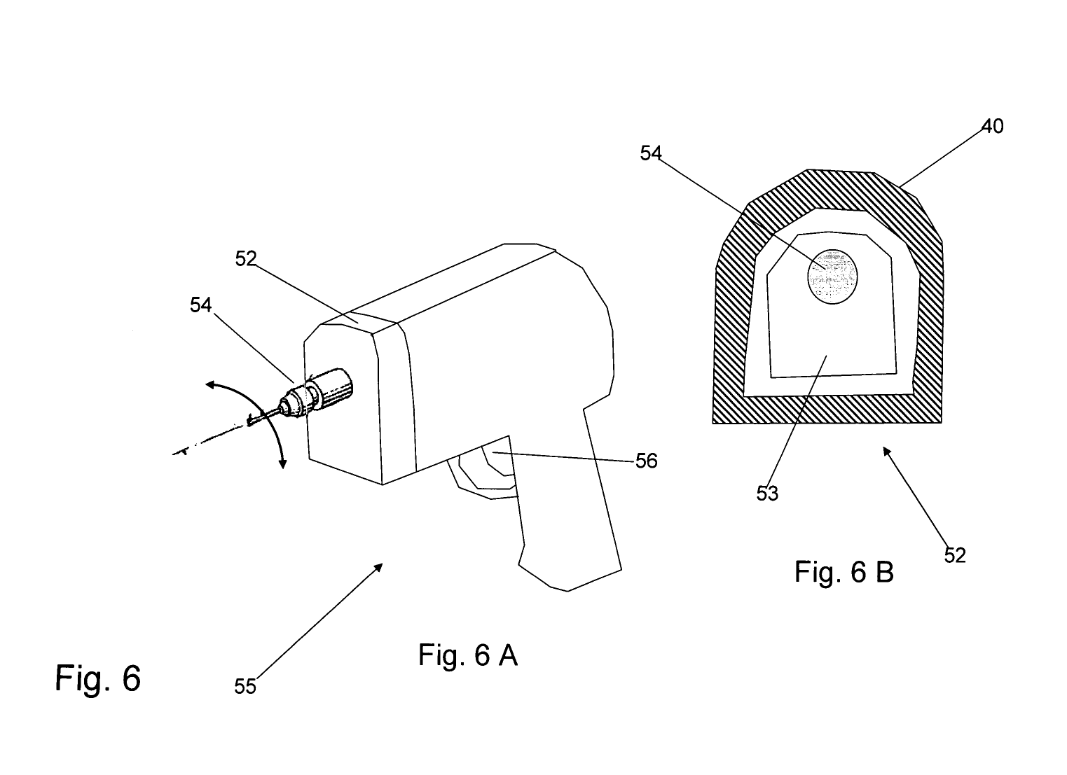

FIGS. 6 A and 6 B are sketches of the electronic controlled reciprocating turning device 55 such as a drill or the like. The out put tool chuck means 54 is connected to the electronically controlled reciprocating component 52. This component 52 produces a reciprocating output by means of the electronic control device 53. One skilled in the electronic controls field well appreciates the plethora of control designs capable of providing this reciprocating control from the straight drive through the electronic control 53. All this is activated by the operating switch 56.

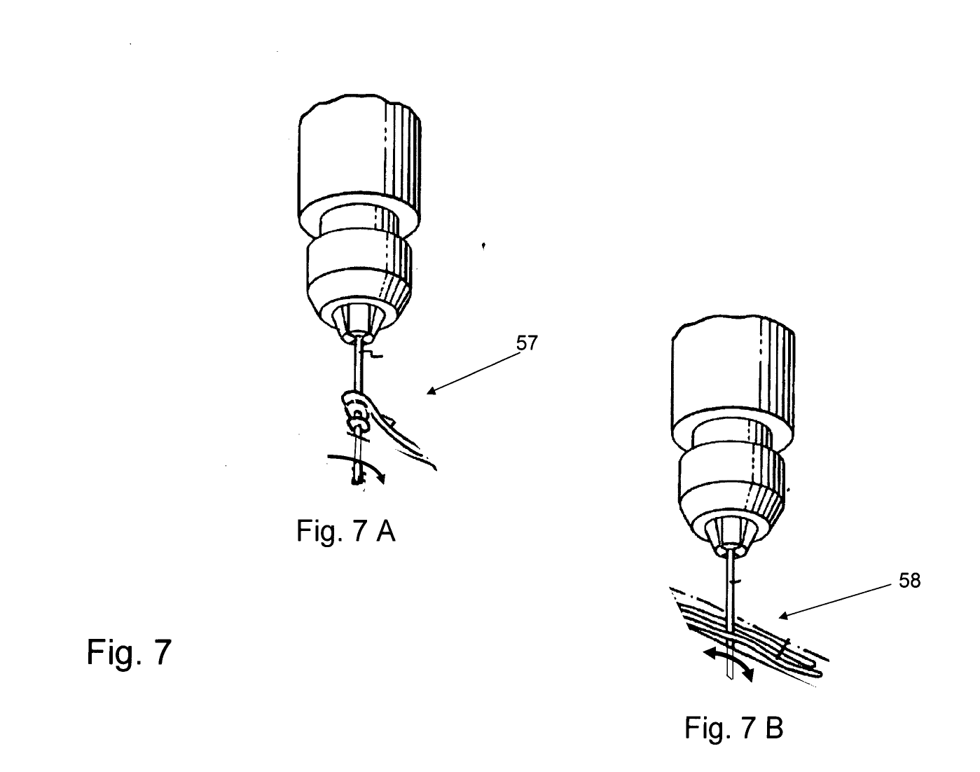

FIGS. 7 A and 7 B are sketches that show The problem addressed. This is discussed in the operation section below.

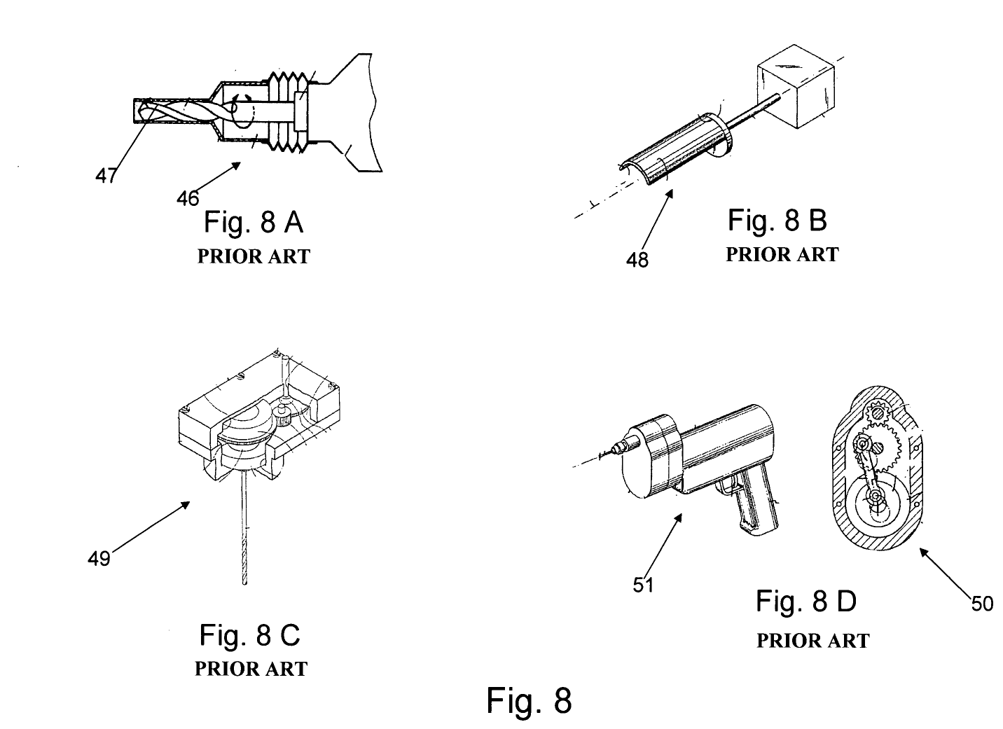

FIGS. 8 A through 8 D are prior art of other turning and reciprocating devices. U.S. Pat. No. 4,111,208 shown in FIG. 8A teaches a process and apparatus for drilling holes in hard materials in surgical procedures. U.S. Pat. No. 4,955,888 shown in FIG. 8B teaches a biradial saw. U.S. Pat. No. 5,030,222 shown in FIG. 8C teaches a radiolucent orthopedic chuck A Method of fixating bone by driving a wire through oscillation was taught by the U.S. Pat. No. 6,110,174 (FIG. 8D

One skilled in the art drill and turning devices appreciates that these drilling devices and system 31, 32, 33 and 33A may be made of various materials. Often, these devices are combinations of materials to keep the designs simple and to lower the costs. Various metals, plastics and composite materials may be used for the main eccentric, disk or gear structures 35, 35A, 36, 37, 37A, and 38. Various thrust bearing or ball bearing devices may provide the connection means 39 of members to an encasement 40. The encasement 40 may be of metals (such as aluminum, steel and the like), plastics and composite materials structures. These may be stamped, molded or cast depending on the selected material and final design configuration. The input and output means 34 and 41 can be of various metals, composites and plastics also and be within the scope and spirit of the device and system.

All of the details mentioned here are exemplary and not limiting. Other specific components specific to describing a drilling device and system 31,32,33,33A may be added as a person having ordinary skill in the field of drilling and turning devices well appreciates.

### Operation of the Preferred Embodiment

The new drilling device and system 31, 32, 33, and 33A have been described in the above embodiment. The manner of how the device operates is described below. One skilled in the art of drill and turning devices will note that the description above and the operation described here must be taken together to fully illustrate the concept of the special drilling device and system. The preferred embodiment described above is essentially comprised of only a few parts as shown in the sketches and drawings. The preferred embodiment of the device is comprised essentially of a reciprocating drive device—offset drive and eccentric bars 32; a turning drive means 34 such as a drill or the like; a drive structure member 35 such as a gear, plate or the like; a reciprocation configuration 36 of various members such as the eccentric linkage 37 to the reciprocating driven structure member 38 such as a gear, plate, linkage or the like; a device encasement 40; a connection means 39 of members to an encasement 40; and a driven output means. One skilled in the art of drilling and turning devices and systems will appreciate the plethora and varied uses anticipated by this new drilling device and system.

Potential uses for this device with the drilling and turning industry as described herein. However, these describe uses are exemplary and not intended as a limitation of anticipated uses for the drilling device and system. The following TABLE B shows additional examples of potential turning and drilling uses.

TABLE B
POSSIBLE TURNING AND DRILLING USES

| ITEM | DESCRIPTION |
|---|---|
| 1 | Carpet and rugs |
| 2 | Foam rubber |
| 3 | Fibrous mats |
| 4 | Quilted materials |
| 5 | Upholstery |
| 6 | Fabrics |
| 7 | Insulations |
| 8 | High splinter wood |
| 9 | Soft wood such as balsa |

Beyond the potential uses, the improved method of operation is shown in FIGS. 7 A and 7 B. FIG. 7 A shows the traditional turning a full 360 degrees and the resultant soft material or fiber being caught and wrapped around the tool—here a drill bit. FIG. 7 B shows the improved operation where the reciprocating tool goes through layers of material without wrapping the material around the tool. The improvement may be well appreciated for those skilled in the art of turning or boring through soft materials such as illustrated above. This expansion of use beyond any medical or surgical field has not been taught or claimed in other publications or patents as far as the search of intellectual property and trade publications has indicated.

With the above description and accompanying drawings, it is to be understood that the drilling device and system 31 is not to be limited to only the disclosed embodiment. The features of the drilling device and system 31 are intended to cover various modifications and equivalent arrangements included within the spirit and scope of the description.

What is claimed is:

1. A general reciprocating drive system 31 made of durable material comprising:
(a) a reciprocating drive means 32 comprising:
1. a direct rotational drive means 34;
2. a means to connect to a direct rotational drive means 34A;
3. a transfer member 35;
4. a reciprocation means 36;
5. an output means 41; and
6. means to connect to a tool 41A
(b) a durable encasement 40;
(c) a means to connect 39 the components of the drive means 31 to the encasement means 40; and
(d) a means 45 to hold the encasement
whereby the rotational drive motion is smoothly transferred into a reciprocating motion to use for turning and drilling soft materials by a person P operating the system.

2. The system according to claim 1 wherein the durable material is a metal.

3. The system according to claim 2 wherein the metal is steel.

4. The system according to claim 2 wherein the metal is aluminum.

5. The system according to claim 1 wherein the durable material is a composite material.

6. The system according to claim 5 wherein the composite material is a plastic.

7. The system according to claim 1 wherein the reciprocation means 36 a configuration of more than one gear and an eccentric bar connected to a gear and the output means 41.

8. The system according to claim 1 wherein the reciprocation means 36 is a configuration of more than one eccentric bars, the first connected to the input means 34A and the last connected to the output means 41.

9. The system according to claim 1 wherein the reciprocation means 36 is a configuration of more than one eccentric bars, the first bar connected to the input means 34A and the last bar connected to the output means 41.

10. A general reciprocating drive system 31 made of durable material comprising:
(a) a direct rotational drive means 34;
(b) a drive shaft 34A;
(c) a direct rotational drive plate 35;
(d) a means to secure the drive shaft 34A to the rotational plate 35;
(e) an eccentric bar 37 with two ends;
(f) a driven plate 38;
(g) a means to connect the bar 37 eccentrically and rotatably at each end of the bar in a rotatable connection, one end connected to the drive plate 35 and the opposite end to the driven plate 38;
(h) an output means 41;
(i) a means to connect to a tool 41A;
(j) an encasement 40; and
(k) a means 39 to hold the components of the system interior to the encasement
whereby the rotational drive motion is smoothly transferred into a reciprocating motion to use for turning and drilling soft materials by a person P operating the system.
